(19) United States
(12) Patent Application Publication
(10) Pub. No.: US 2017/0217815 A1
(43) Pub. Date: Aug. 3, 2017

(54) METHOD AND APPARATUS FOR REFORMING ULTRA-THIN GLASS SHEETS

(71) Applicant: CORNING INCORPORATED, CORNING, NY (US)

(72) Inventors: Thierry Luc Alain Dannoux, Avon (FR); Laurent Joubaud, Paris (FR)

(21) Appl. No.: 15/500,305

(22) PCT Filed: Jul. 29, 2015
(86) PCT No.: PCT/US15/42574

§ 371 Date: Jan. 30, 2017

Related U.S. Application Data
(60) Provisional application No. 62/030,637, filed on Jul. 30, 2014.

(51) Int. Cl. C03B 23/025

(52) U.S. Cl. CPC C03B 23/0256

(57) ABSTRACT

Methods and apparatus provide for an ultra-thin glass sheet having a thickness of less than about 0.3 mm, being of a non-developable 3D shape, and including at least one bend having a radius of curvature of less than about 200 mm.

### CROSS-REFERENCE TO RELATED APPLICATIONS

This application claims the benefit of priority under 35 U.S.C. §119 of U.S. Provisional Application Ser. No. 62/030,637 filed on Jul. 30, 2014, the content of which is relied upon and incorporated herein by reference in its entirety.

### BACKGROUND

The present disclosure is directed to methods and apparatus for processing glass sheets, specifically ultra-thin glass sheets, such as for deformation of the glass sheets during a manufacturing process.

Conventional techniques for providing a flexible transparent or translucent substrate have involved the use of plastic substrates, such as a plastic base material laminated with one or more polymer films. These laminated structures are commonly used in flexible packaging associated with photovoltaic (PV) devices, organic light emitting diodes (OLED), liquid crystal displays (LCD) and patterned thin film transistor (TFT) electronics, mostly because of their relatively low cost. Although the aforementioned flexible plastic substrates have come into wide use, they nevertheless exhibit poor characteristics in connection with at least providing a moisture barrier and providing very thin structures (indeed, the structures are relatively thick owing to the properties of plastic materials).

Accordingly, there are needs in the art for flexible substrates for use in, for example, PV devices, OLED devices, LCDs, TFT electronics, etc., particularly where the substrate is to provide a moisture barrier.

Flexible glass substrates offer several technical advantages over the existing flexible plastic substrate in use today. One technical advantage is the ability of the glass substrate to serve as good moisture or gas barrier, which is a primary degradation mechanism in outdoor applications of electronic devices. Another advantage is the potential for the flexible glass substrate to reduce the overall package size (thickness) and weight of a final product through the reduction or elimination of one or more package substrate layers. As the demand for thinner, flexible substrates (of the thickness mentioned herein) increases in the electronic display industry, manufacturers are facing a number of challenges for providing suitable flexible substrates.

A significant challenge in fabricating flexible glass substrate for PV devices, OLED devices, LCDs, TFT electronics, etc., is forming the generally planar sheet into a non-planar (three dimensional, 3D) shape, such as by bending, etc. Although glass reforming (under temperature) is a conventional technique of shaping planar glass sheets into 3D shapes, there are particular challenges in producing a non-developable, 3D shaped part from an ultra-thin glass sheet, specifically at thicknesses of less than about 0.3 mm, for example as low as about 0.05 mm. These challenges are magnified when processing goals include one or more of the following characteristics: (i) a non-developable 3D shape, (ii) a thickness of less than about 0.3 mm, (iii) a low thickness variation of less than about +/−0.05 mm, (iv) a low radius of curvature of less than about 200 mm, (v) very low or no tensile stress, and (vi) very low or no birefringence related light distortion.

Thus, there are needs for methods and apparatus for producing a non-developable, 3D shaped part from an ultra-thin glass sheet that exhibits one or more of the above-noted characteristics.

### SUMMARY

The glass properties of an ultra-thin glass sheet may be combined with a very high degree of flexibility and a low specific weight. This combination yields a large potential for commercial applications. For example, such ultra-thin glass sheets are a key enabler for slim displays of the future, as well as the development of conformable displays for immersive viewing (owing to their flexibility).

By employing ultra-thin glass sheets, it is possible to cylindrically bend the sheet to quite low radii of curvature (typically 200 to 50 mm radius of curvature) without breaking the glass. Furthermore, the ultra-thin characteristic of the glass results in very little tensile stress during a cold-bending operation, indeed the tensile stress may be sufficiently low to avoid glass breakage. Nevertheless, to enjoy the advantages of ultra-thin glass (light weight, high optical transmission, etc.) with a 3D shaped product, which presents non-developable deformations and/or low radii of curvature, the cold-bending approach is not a valid process. Indeed, the tensile stresses induced by such a cold-bending would be unacceptable and the glass part would break.

It is thus desirable to develop techniques to obtain such shaped products with ultra-thin sheets and without creating any elastic tensile stresses.

In one or more broad aspects, methods and apparatus provide for an ultra-thin glass sheet having a thickness of less than about 0.3 mm, being of a non-developable 3D shape, and including at least one bend having a radius of curvature of less than about 200 mm.

Directional terms such as “top”, “upward”, “bottom”, “downward”, “rearward”, “forward”, etc. may be used herein; however, they are for convenience of description and should not be interpreted as requiring a certain orientation of any item unless otherwise noted.

The term “relatively large” or “large” as used in this description and the appended claims in relation to a glass sheet means a glass sheet having a dimension of 1 meter or more in at least one direction.

The term “relatively high CTE” or “high CTE” as used in this description and the appended claims in relation to a glass sheet means a glass or glass sheet having a CTE of at least 70×10⁻⁷ C¹.

The term “relatively thin” or “thin” as used in this description and the appended claims in relation to a glass sheet means a glass sheet having a thickness in a range of from about 0.5 mm to about 1.5 mm.

The phrase “ultra-thin” as used in this description and the appended claims in relation to a glass sheet means a glass sheet having a thickness of less than about 0.3 mm.

The phrase “non-developable 3D shape” may be defined as a shape with non-zero Gaussian curvature, e.g., the 3D shape cannot be flattened onto a plane without distortion (e.g., stretching distortion and/or compressing distortion).

Other aspects, features, and advantages of one or more embodiments disclosed and/or described herein will be apparent to one skilled in the art from the description herein taken in conjunction with the accompanying drawings.

### BRIEF DESCRIPTION OF THE DRAWING

For the purposes of illustration, there are forms shown in the drawings that are presently preferred, it being understood, however, that the embodiments disclosed and/or described herein are not limited to the precise arrangements and instrumentalities shown.

FIGS. 1a and 1b are schematic edge and top views, respectively, of a reformed glass sheet in accordance with one or more embodiments herein;

FIGS. 2a and 2b are schematic edge and top views, respectively, of a reformed glass sheet in accordance with one or more embodiments herein;

FIGS. 3a and 3b are schematic edge and top views, respectively, of a reformed glass sheet in accordance with one or more embodiments herein;

FIG. 4 is a schematic side view of an example of an apparatus for producing sheets of ultra-thin glass in accordance with one or more embodiments herein;

FIGS. 5-7 illustrate a process for bending the glass sheet into the shape illustrated in FIG. 1 in accordance with one or more embodiments herein; and

FIG. 8 is a graph illustrating characteristics of a reforming process, specifically viscosity of the glass sheet during bending as compared with other reforming processes.

### DETAILED DESCRIPTION

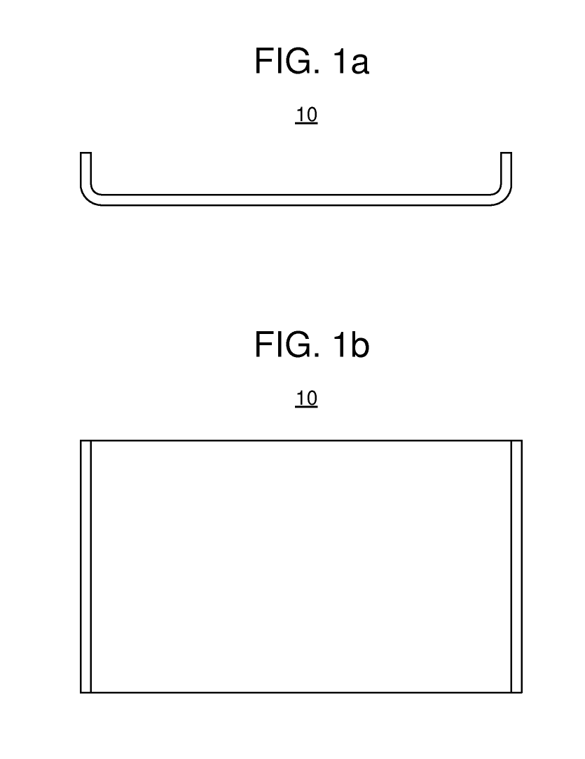

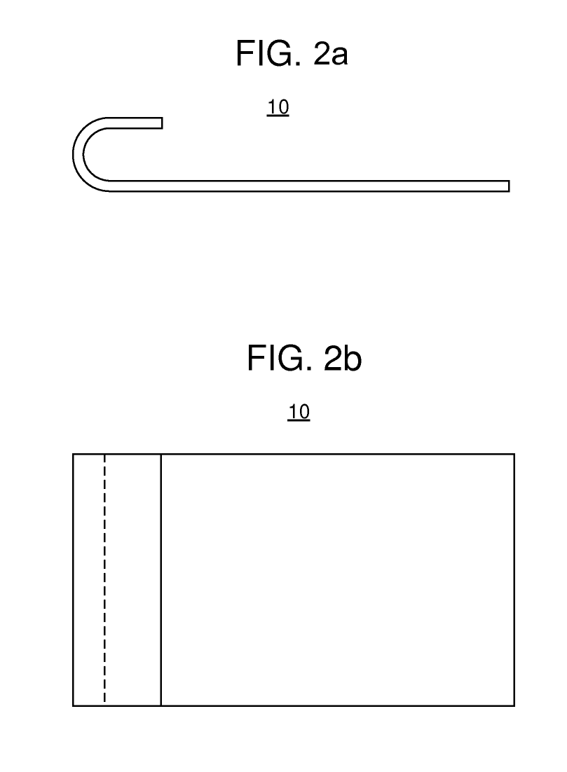

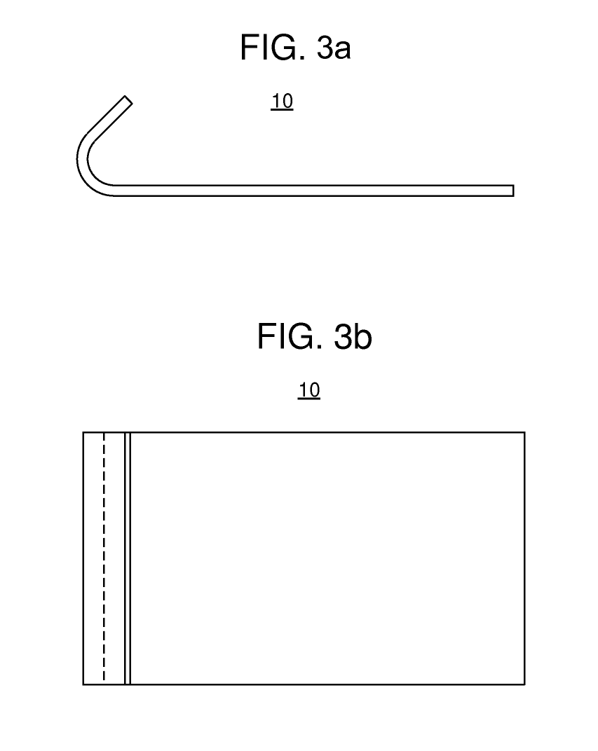

With reference to the drawings wherein like numerals indicate like elements there are shown in FIGS. 1, 1a, 2, 2a, 3, and 3a schematic illustrations (edge and top views, respectively) of various embodiments of ultra-thin reformed glass sheets 10 that may be used as a glass cover for any number of applications. The ultra-thin glass sheets 10 are characterized by the fact that they have thicknesses of less than about 0.3 mm, such as less than about 0.2 mm, less than about 0.1 mm, and/or between about 0.05 mm and about 0.1 mm Further, the ultra-thin glass sheets 10 may preferably also have a thickness variation of less than about +/−0.05 mm.

Further, the glass sheets 10 are characterized by the fact that they exhibit a non-developable 3D shape, including at least one bend. The at least one bend may be characterized as having a relatively small radius of curvature, such as less than about 200 mm, less than about 100 mm, less than about 50 mm, between about 25 mm to about 50 mm, and/or between about 1 and 2 mm.

In addition, the glass sheets 10 are characterized by the fact that they exhibit substantially no tensile stress and/or no birefringence related light distortion. In one or more embodiments the glass sheets 10 are characterized by the fact that they exhibit substantially no tensile stress one at least one major surface thereof (e.g., as would be the case when there may be some stress in the bulk of the glass sheets 10).

The glass sheets 10 may be formed from any suitable glass composition. By way of example, some applications may best be served using glass sheets 10 that have been chemically strengthened using an ion exchange process, such as Gorilla® glass from Corning Incorporated. Such glass is may be made ultra-thin and lightweight and may yield a glass cover with enhanced fracture and scratch resistance, as well as enhanced optical and touch performance.

As noted above, it is very challenging to produce the glass sheets 10, when processing goals include one or more (and especially all) of the following characteristics: (i) a non-developable 3D shape, (ii) a thickness of less than about 0.3 mm, (iii) a low thickness variation of less than about +/−0.05 mm, (iv) a low radius of curvature of less than about 200 mm, (v) very low or no tensile stress, and (vi) very low or no birefringence related light distortion.

These challenges are further magnified when assembly tolerances for the finished part are on the order of +/−0.5 mm or less in order to provide the desired quality look, feel, fit and finish for an electronic or other device. Such tolerances are difficult to achieve when performing high temperature precision bending (which will be discussed in further detail later herein) on relatively large glass sheets 10 (e.g., having a major dimension of about 1 meter or more). This tolerance issue is particularly difficult for ion exchangeable glasses. Indeed, ion exchangeable glasses typically have a relatively high CTE and when heating a relatively large glass sheet 10 to a temperature sufficient to soften the glass to the point that forming is possible (e.g., about 600° to 700° C.), a number of factors must be addressed in order to maintain high precision tolerances.

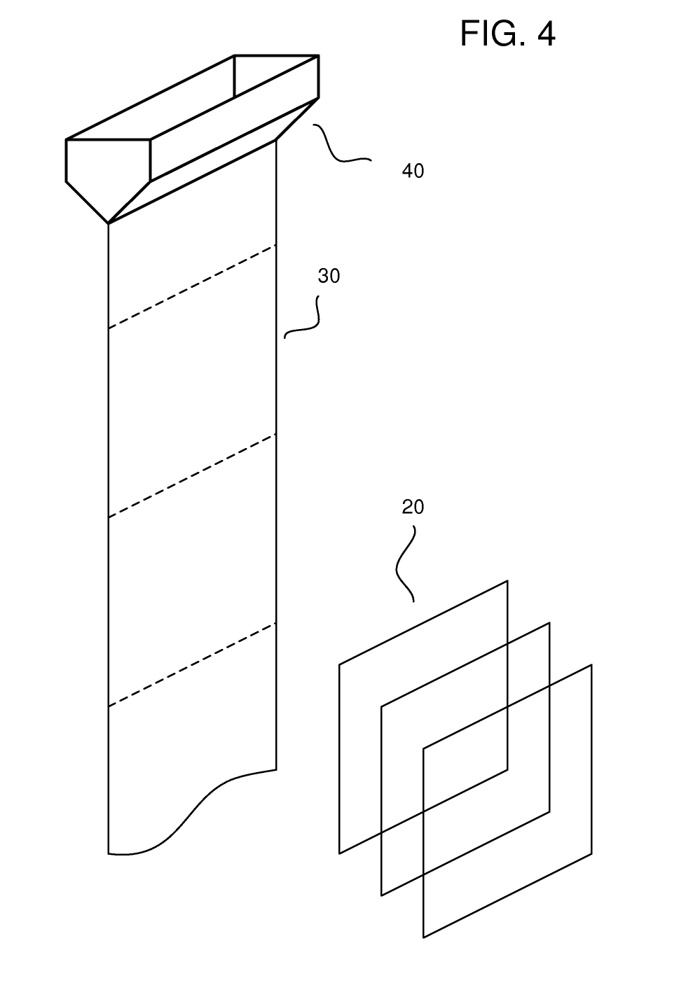

With reference to FIG. 4, in an initial phase, raw glass sheets 20 are fabricated by flowing molten glass to produce a glass ribbon 30. The glass ribbon 30 may be formed via any number of ribbon forming process techniques, for example, slot draw, float, down-draw, fusion down-draw, or up-draw. In the illustrated example, the glass ribbon 30 may be formed via a slot draw process from a trough 40. The glass ribbon 30 may then be subsequently divided to provide the glass sheets 20 suitable for further processing into intermediate shapes for final products.

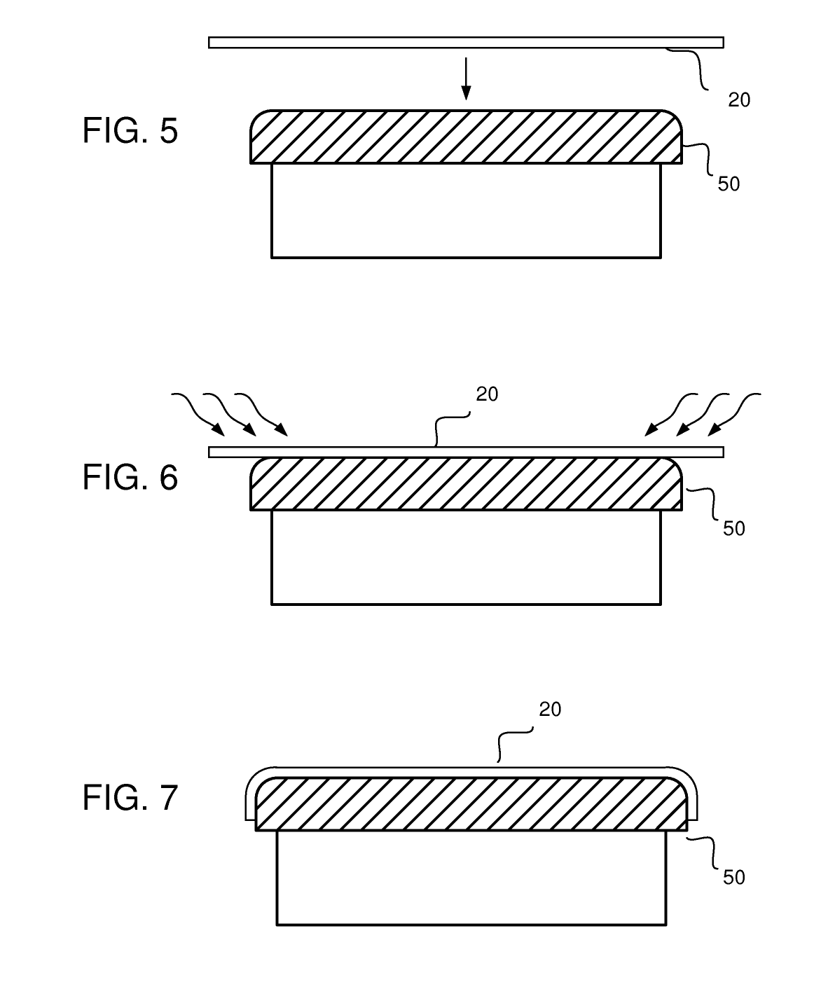

As illustrated in FIGS. 5-7, a raw glass sheet 20 may be reformed into the glass sheet 10 of a desired shape. In this regard, the raw glass sheet 20 is supported on a carrier 50 (e.g., a frame or mold). The glass sheet 20 and the carrier 50 are then placed in a bending furnace (not shown) and/or heat is applied via a localized heating source in order to raise the temperature of the glass sheet 20 to between the annealing temperature and the softening temperature thereof For example, the glass sheet 20 may be brought to a temperature approaching about 600° C.-900° C., depending on the composition of the glass sheet 20.

The glass sheet 20 may then be permitted to sag under the influence of gravity and/or a mechanical bending mechanism (e.g., a pushing element, roller, vacuum forming, etc., not shown) may be applied in order to form the glass sheet 20 to the shape of the underlying carrier 50, especially the molding elements of the carrier 50. As noted above, the reformed glass sheet 10 includes at least one bend having a relatively small radius of curvature, such as less than about 200 mm, less than about 100 mm, less than about 50 mm, between about 25 mm to about 50 mm, and/or between about 1 and 2 mm.

As shown in by the progression of FIGS. 5-7, the glass sheet 20 is reformed into the glass sheet 10, and is then cooled.

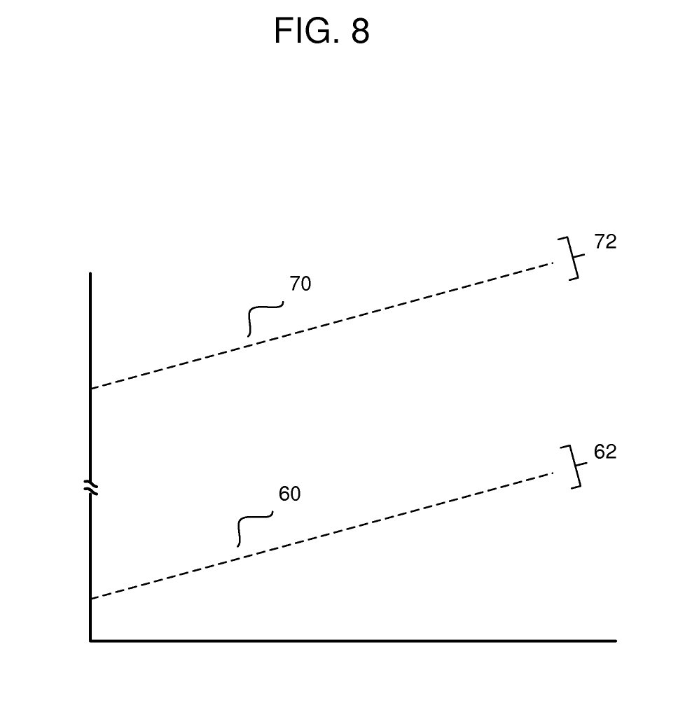

A noteworthy aspect of the heating and bending steps will now be discussed with respect to FIG. 8. In particular, the heating step is preferably controlled such that the viscosity of the raw glass sheet 20 is at least one order of magnitude greater than a reforming viscosity for a relatively thicker reference glass sheet. In other words, the viscosity of the ultra-thin glass sheet 20 is significantly higher than the viscosity employed in conventional glass reforming processes. Indeed, as shown in FIG. 8, the Y-axis represents viscosity (for example in Poise or Pascal seconds) and the X-axis represents differing glass compositions and/or characteristics. The plot 60 represents a range of viscosity that would be employed in a reforming process to achieve bending using conventional techniques on glass sheets that are relatively thicker, e.g., between about 0.5 mm and 1.0 mm. Thus there is a range 62 around the plot 60 that represents the possible reforming viscosities of a reference glass sheet between about 0.5 mm and 1.0 mm, which may be between about 10⁸ to about 10¹² Poise. In contrast, there is a range 72 around the plot 70 of viscosity that would be employed in the reforming process to achieve bending using ultra-thin glass sheets 20, e.g., less than about 0.3 mm, which is at least about one order of magnitude less than the possible reforming viscosities of the reference glass sheet. Thus, the range of viscosity for reforming the ultra-thin glass sheets 20 into the glass sheets 10 is at least about 10¹³ Poise.

In order to form a plurality of glass sheets 10 in a continuous fashion, a plurality of carriers 50 may be located on a continuously moving conveyor for conveying the glass sheets 10 through a multi-zone bending furnace in a serial fashion. The glass sheets 10 are disposed onto the carriers 50 at a relatively cool ambient environment (e.g., room temperature) upstream from the furnace. A first of the zones may be a preheating zone, in which the glass sheets 10 are heated to a temperature close to their annealing temperature. The overall preheating zone may include a plurality of pre-heating zones, each at an increasing temperature for sequentially increasing the temperature of the glass sheets 10 as they are conveyed through the zones.

The next zone is a bending zone, where the glass sheets 10 are elevated to a processing or bending temperature, such as a temperature between the annealing temperature and the softening temperature, for example, a temperature approaching about 600° C.-900° C. Again, in preferred embodiments, the viscosity of the glass sheets 10 are at least an order of magnitude higher than a reforming viscosity for a relatively thicker reference glass sheet, such as at least about 10¹³ Poise. The bending zone provides the glass sheets 10 with an environment suitable to mold to the shape of the underlying carriers 50. This may involve heating the entire bending zone to the temperature of between about 600° C.-900° C. or it may involve providing a lower ambient temperature within the bending zone and employing one or more local heating elements to elevate particular areas of the glass sheets 10 (e.g., certain edges) to the higher temperature. Within the bending zone, the glass sheets 10 may be permitted to bend under gravity and/or they may receive mechanical force to urge the glass sheets 10 into conformity with the underlying mold feature of the carriers 50.

The glass sheets 10 are cooled in a cooling zone to the external ambient temperature and then removed from the furnace.

Although the embodiments herein have been described with reference to particular features and arrangements, it is to be understood that these details are merely illustrative of the principles and applications of such embodiments. It is therefore to be understood that numerous modifications may be made to the illustrative embodiments and that other arrangements may be devised without departing from the spirit and scope of the appended claims.

1. An apparatus, comprising: an ultra-thin glass sheet having a thickness of less than about 0.3 mm, being of a non-developable 3D shape, and including at least one bend having a radius of curvature of less than about 200 mm.

2. The apparatus of claim 1, wherein the glass sheet has a thickness of less than about 0.2 mm.

3. The apparatus of claim 1, wherein the glass sheet has a thickness of less than about 0.1 mm.

4. The apparatus of claim 1, wherein the glass sheet has a thickness of between about 0.05 mm and about 0.1 mm.

5. The apparatus of claim 1, wherein the glass sheet has a thickness variation of less than about +/−0.05 mm.

6. The apparatus of claim 1, wherein the at least one bend has a radius of curvature of less than about 100 mm.

7. The apparatus of claim 1, wherein the at least one bend has a radius of curvature of less than about 50 mm.

8. The apparatus of claim 1, wherein at least one of:
the at least one bend has a radius of curvature of between about 25 mm to about 50 mm; and the at least one bend has a radius of curvature of between about 1 and 2 mm.

9. The apparatus of claim 1, wherein the glass sheet exhibits substantially no tensile stress on at least one major surface thereof.

10. The apparatus of claim 1, wherein the glass sheet exhibits substantially no birefringence related light distortion.

11. A method, comprising:
heating an ultra-thin glass sheet having a thickness of less than about 0.3 mm to a temperature sufficient to lower a viscosity of the glass sheet; and bending the glass sheet to produce a non-developable 3D shape including at least one bend having a radius of curvature of less than about 200 mm,
wherein the heating step is controlled such that the viscosity of the glass sheet is at least one order of magnitude greater than a reforming viscosity for a reference glass sheet, the reference glass sheet being of a thickness between about 0.5 mm to about 1 mm.

12. The method of claim 11, wherein the reforming viscosity of the reference glass sheet is between about 10⁸ to about 10¹² Poise.

13. The method of claim 11, wherein the viscosity of the glass sheet is at least about 10¹³ Poise.

14. The method of claim 11, wherein the glass sheet has a thickness of less than about 0.2 mm.

15. The method of claim 11, wherein the glass sheet has a thickness of less than about 0.1 mm.

16. The method of claim 11, wherein the glass sheet has a thickness of between about 0.05 mm and about 0.1 mm.

17. The method of claim 11, wherein the glass sheet has a thickness variation of less than about +/−0.05 mm.

18. The method of claim 11, wherein the at least one bend has a radius of curvature of less than about 100 mm.

19. The method of claim 11, wherein the at least one bend has a radius of curvature of less than about 50 mm.

20. The method of claim 11, wherein at least one of: the at least one bend has a radius of curvature of between about 25 mm to about 50 mm; and the at least one bend has a radius of curvature of between about 1 and 2 mm.
